(19) United States
(12) Patent Application Publication
(10) Pub. No.: US 2024/0289734 A1
(43) Pub. Date: Aug. 29, 2024

(54) SECURE SHIPPING USING PHYSICAL INTERNET

(71) Applicant: INTERNATIONAL BUSINESS MACHINES CORPORATION, ARMONK, NY (US)

(72) Inventors: Shoichiro Watanabe, Tokyo (JP); Yasutaka Nishimura, Yamato-shi (JP); Kenichi Takasaki, Tokyo (JP); Sanehiro Furuichi, Tokyo (JP); Mari Abe Fukuda, Tokyo (JP)

(21) Appl. No.: 18/173,492

(22) Filed: Feb. 23, 2023

(51) Int. Cl. G06Q 10/0835

(52) U.S. Cl. CPC G06Q 10/08355

(57) ABSTRACT

A system, method, and computer program product receive a request for delivery of a package from an origin to a destination with a desired degree of information disclosure using the Physical Internet. A first carrier for a first leg of the delivery is determined based on the origin and an area coverage of the first carrier. The first carrier is not provided destination information as dictated by the desired degree of information disclosure. A candidate list of other carriers for transporting the package in one or more subsequent legs is identified based on the historical performances of each of the other carriers and the desired degree of information disclosure. A final carrier from the candidate list is determined for a final leg of the delivery. The destination information is disclosed to the final carrier.

### BACKGROUND

The Physical Internet refers to a plurality of digital transportation networks that are being utilized to replace other historical logistical models. Specifically, the Physical Internet is an open global logistics system founded on the connectivity of digital operations and physical assets as captured within a logistical model. The Physical Internet operates by manipulating (typically standardized) containers that are explicitly designed for the Physical Internet, where these containers encapsulate goods that are being shipped via the Physical Internet.

### SUMMARY

Aspects of the present disclosure relate to a method, system, and computer program product relating to a receiving a request for delivery of a package from an origin to a destination with a desired degree of information disclosure using the Physical Internet. The method further includes determining a first carrier for a first leg of the delivery based on the origin and an area coverage of the first carrier. The first carrier is not provided destination information as dictated by the desired degree of information disclosure. The method further includes identifying a candidate list of other carriers for transporting the package in one or more subsequent legs based on the historical performances of each of the other carriers and the desired degree of information disclosure. The method further includes determining a final carrier from the candidate list for a final leg of the delivery. The destination information is disclosed to the final carrier. A system and computer program configured to execute the method described above are also described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which controller may enable secure transportation of a package to a destination using the Physical Internet.

FIG. 2 depicts an example flowchart by which the controller of FIG. 1 may enable secure transportation of the package.

FIG. 3 depicts a conceptual box diagram of a computing system that may host and/or include the controller of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to secure shipment of packages using the Physical Internet, while more particular aspects of the disclosure relate to shipping a package using the Physical Internet while only providing certain details of how to deliver the package to only the final carrier of a sequence of carriers. While the present disclosure is not necessarily limited to such applications, various aspects of the disclosure may be appreciated through a discussion of various examples using this context.

The Physical Internet (PI) is an open global logistics system founded on physical, digital, and operational interconnectivity, through encapsulation, interfaces, and protocols. The Physical Internet is intended to replace current logistical models. The PI operates by dynamically aggregating packages as much as possible in order to improve the utilization rate of various transportation resources. For example, when packages are transported by conventional means (e.g., not using the PI), there may be some warehouses and/or transportation vehicles (e.g., trucks, planes, trains, ships, etc.) that have significant underused capacity, while other nearby warehouse and/or transportation vehicles are at capacity such that packages are being delayed. The PI enables the optimization of these transportation assets (where transportation assets include warehouses, transportation vehicles, and the like) via the aforementioned aggregation of packages. For example, aggregating packages includes comparing a full trip of a significant amount of packages against all transportation assets—where these aggregated packages are typically shipped largely using standardized containers-to find optimizations.

However, by pooling together information in this way it may be difficult to keep certain information of certain packages secure. For example, a package may need to be delivered to a place that requires entering a key code, or a package may need to be delivered to a location that is not publicly known to be associated with the person that ordered the package, or the like. In such a situation, using the PI may frustrate the intended level of secrecy, as the aggregation of packages may, by default, give all/numerous carriers of the package (and numerous other packages that may be within the standardized container) access to the secure information.

Aspects of this disclosure may solve or address these problems by keeping the disclosure of secure information (e.g., who is the sender, who is the recipient, certain destination information, etc.) related to delivery undisclosed to one or more carriers, but rather to disclose this secure information only a subset of carriers. For example, aspects of this disclosure may only disclose this secure information to the minimum number of carriers/people necessary to successfully execute the delivery. One or more computing devices that include one or more processing units executing instructions stored on one or more memories may provide the functionality that addresses these problems, where said computing device(s) are herein referred to as a controller.

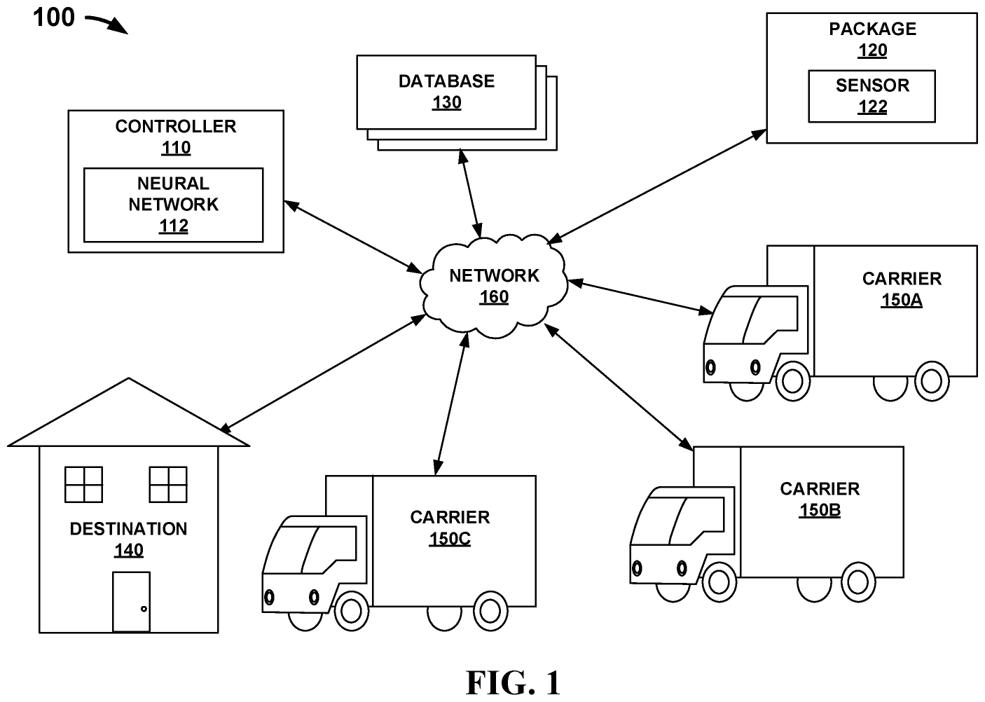

For example, FIG. 1 depicts environment 100 in which controller 110 may secure packages 120 transported using PI. Controller 110 may manage the transportation of package 120 to destination 140 via carriers 150A-150C (collectively, “carriers 150”) using data from database 130. Though carriers 150 are depicted as being vehicles in FIG. 1 for purposes of illustration, in other examples carriers 150 as used herein may refer to any entity that controls and/or has access to information regarding packages 120. For example, carriers 150 may refer to warehouses that may store packages 120, delivery management companies that employ vehicle drivers, or the like.

Controller 110 enables a client (e.g., a person who requests package 120 be shipped) to select a desired degree of information disclosure (e.g., what information is secure, and who has access to the secure information). Controller 110 may further enable the client to select a delivery option (e.g., how, what, when, where packages 120 are delivered), as well as enabling a user to select and/or provide one or more allowlists or denylists as to which carriers 150 can be used for which legs of a transportation journey. In this way, aspects of the disclosure may maintain the flexibility and optimizing aspects of PI while also providing a way for information to be secure in a way that it is often not when packages 120 are shipped via PI.

Controller 110 may interact with carriers 150, database 130, clients of destination 140, and the like using network 160. Network 160 may include a computing network over which computing messages may be sent and/or received. For example, network 160 may include the Internet, a local area network (LAN), a wide area network (WAN), a wireless network such as a wireless LAN (WLAN), or the like. Network 160 may comprise copper transmission cables, optical transmission fibers, wireless transmission, routers, firewalls, switches, gateway computers and/or edge servers. A network adapter card or network interface in each computing/processing device (e.g., computing devices that host/include databases 130, or computing devices that relate to carriers 150) may receive messages and/or instructions from and/or through network 160 and forward the messages and/or instructions for storage or execution or the like to a respective memory or processor of the respective computing/processing device. Though network 160 is depicted as a single entity in FIG. 1 for purposes of illustration, in other examples network 160 may include a plurality of private and/or public networks.

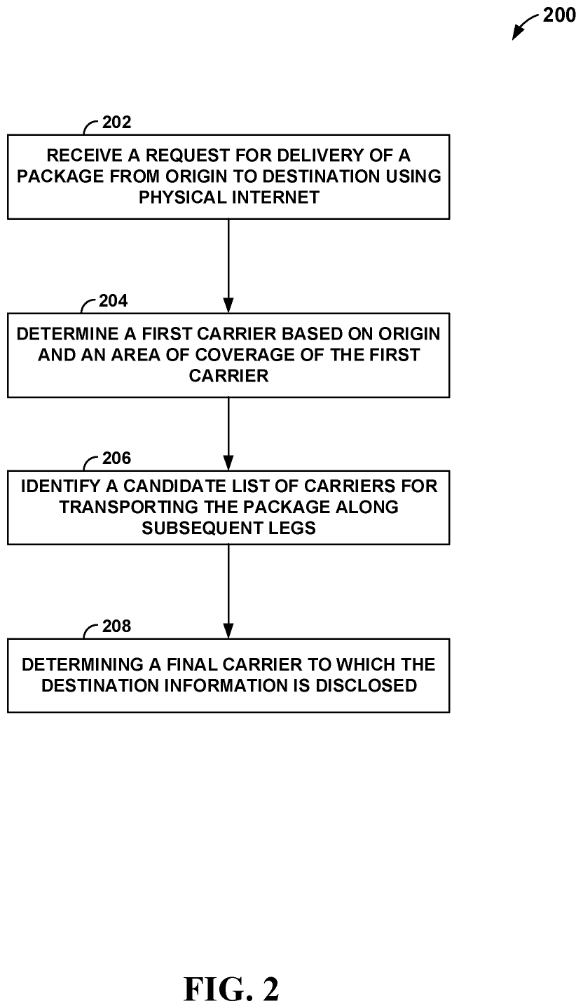

Controller 110 may manage the secure transportation of packages 120 over PI according to flowchart 200 depicted in FIG. 2. Flowchart 200 of FIG. 2 is discussed with relation to FIG. 1 for purposes of illustration, though it is to be understood that other environments with other components may be used to execute flowchart 200 of FIG. 2 in other examples. Further, in some examples controller 110 may execute a different method than flowchart 200 of FIG. 2, or controller 110 may execute a similar method with more or less steps in a different order, or the like.

Controller 110 receives a request for delivery of package 120 from an origin to destination 140 using the Physical Internet (202). The request, as received by controller 110, includes a desired degree of information disclosure. The request may further include other details needed to quantify a shipping request, such as a location of a destination, an identify of a sender, an identify of a recipient, and/or various shipping options (e.g., desired shipping method, whether refrigeration is required, or the like).

Controller 110 may facilitate the client/user providing this desired degree of information disclosure by guiding the user through a user interface (UI) that provides various options for differing amounts of information disclosure. Controller 110 may calculate how different amounts of information disclosure may impact a price of shipping package 120. In certain embodiments (e.g., for particularly robust shipments involving a significant amount of packages 120 moving a significant distance), controller 110 may utilize a neural network 112 as described herein to analyze how different amounts of information disclosure may impact the transportation, such as by changing potential dates of delivery (e.g., where demanding more secrecy may slow the date by which packages 120 may be delivered). Controller 110 may use such a neural network 112 to provide real-time feedback to a user as the user toggles between different potential possibilities regarding what information is to be kept secure, so that a user may select the amount/type of information security that fits their needs and preferences. For example, a given client may wish that only one of a very select group of carriers 150 can pick up package 120 from a source and deliver package 120 to destination 140, though there are no restrictions for any carriers 150 that do not pick up package from the source or deliver package 120 to destination 140.

Controller 110 determines a first carrier 150A for a first leg of the delivery based on the origin and an area coverage of the first carrier 150A (204). Controller 110 may engage the first carrier 150A without providing the first carrier 150A some destination information as dictated by the desired degree of information disclosure. For example, controller 110 may merely tell the first controller 110 an origin where they can pick up package 120 and an intermediate destination where first carrier 150A is to deliver package 120, and an estimate arrival time that first carrier 150A is to aim for. In some examples, controller 110 may engage first carrier 150 via a transportation management organization that employs carriers 150, where certain transportation management organizations may be explicitly on the allowlist/denylist as well.

Controller 110 identifies a candidate list of other carriers 150 for transporting package 120 along one or more subsequent legs (206). Controller 110 may identify this list of other potential carriers based on the desired degree of information disclosure provided by the client. Further, controller 110 may identify this list based on the historical performances of each of the other carriers 150 as provided within database 130. For example, historical performances may include statistical information that calculates routes through which package 120 could be shipped, which carriers 150 have good historical performance (e.g., fast times, no accidents, etc.) along these routes, or the like. In some examples, controller 110 may utilize neural network 112 to analyze this statistical data to identify carriers 150 that satisfy parameters of the client. In some examples, controller 110 (e.g., as part of a transportation management organization) may schedule out a full set of carriers 150, which may include two, three, or more people/organizations that take possession of the package 120 for periods of time, though as discussed herein only the final carrier may be the one that has destination information.

Controller 110 determines a final carrier 150C from the candidate list for a final leg of the delivery (208). Controller 110 discloses the destination information to the final carrier 150C. This may include such things as a location/address of destination 140, a code/name to reference in order to get to destination 140 to drop off package, an identify of the recipient. In some examples, controller 110 may receive instructions from a user specifying how close anyone that is not on the allowlist can bring package 120 to destination 140. For example, controller 110 may receive instructions that say that a penultimate carrier 150B must hand off package 120 to a final carrier 150C at least one mile away from destination 140. In other examples, the predetermined distance may be geopolitical, such as being outside of city limits, or outside of a state of destination 140. Other examples of the predetermined distance are also possible.

In some examples, controller 110 may track package 120 as package 120 is shipped using sensor 122. Sensor 122 may be attached to package 120 as depicted in FIG. 1 (e.g., some form of geo-tag), though in other examples, sensor 122 may include a camera that is removed from package 120 that scans a barcode on package 120, or the like. Using sensor 122, controller 110 may verify where package 120 is at and provide real-time updates to user, and/or update a determined carrier 150 list as package is shipped.

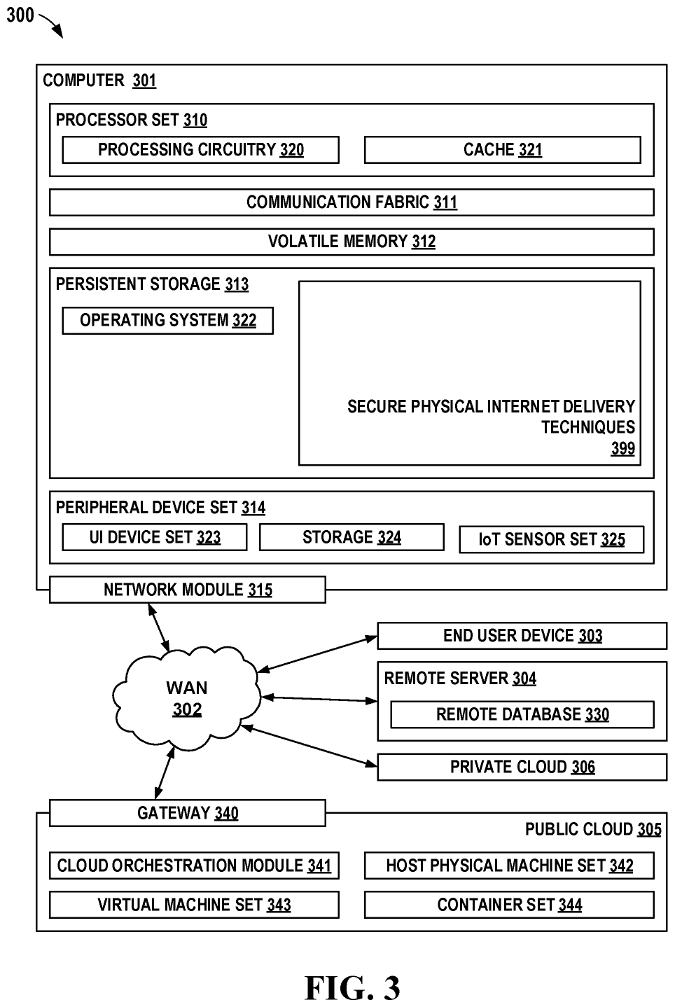

As described above, controller 110 may include or be part of a computing device that includes a processor configured to execute instructions stored on a memory to execute the techniques described herein. For example, FIG. 3 is a conceptual box diagram of a computer 301 that can host controller 110. While controller 110 is depicted as a single entity (e.g., within a single housing) for the purposes of illustration, in other examples, controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Computing environment 300 contains an example of an environment for the execution of at least some of the computer code involved in performing the inventive methods, such as secure PI delivery techniques 399. In addition to under secure PI delivery s techniques 399, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and secure PI delivery techniques 399, as identified above), peripheral device set 314 (including user interface (UI) device set 323, storage 324, and Internet of Things (IoT) sensor set 325), and network module 315. Remote server 104 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in secure PI delivery techniques 399 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in secure PI delivery techniques 399 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

In addition to secure PI delivery techniques 399, in some examples gathered or predetermined data or techniques or the like as used by processor set 310 to manage underwater machinery performance. For example, persistent storage 313 may include information described above that is gathered from environment 100. Specifically, memory 313 may include some or all data gathered from sensors 122, and/or persistent storage may include some or all data of historical databases 130.

Further, persistent storage 313 may include threshold and preference data. Threshold and preference data may include thresholds that define a manner in which controller 110 is to manage transportation of packages 120. For example, the threshold and preference data may include thresholds at which controller 110 executes various tasks as described above, such as user-provided thresholds. For another example, threshold and performance data may include thresholds at which controller 110 is to reroute packages 120. For example, controller 110 may be configured to autonomously redirect any packages 120 away from given carriers 150, such as in response to determining that one or more carriers 150 is associated with conditions that a client identifies as being unsecure.

Persistent storage 313 may further include machine learning techniques that controller 110 may use to improve a process of securing packages transported using PI as described herein over time. Machine learning techniques can comprise algorithms or models that are generated by performing supervised, unsupervised, or semi-supervised training on a dataset, and subsequently applying the generated algorithm or model to manage underwater machinery performance. Using these machine learning techniques, controller 110 may improve an ability to route packages 120 using allow-lists and while avoiding denylists in a way that users find preferable.

Machine learning techniques can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques. Specifically, machine learning techniques can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, 1-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

What is claimed is:

1. A computer-implemented method comprising:
receiving a request for delivery of a package from an origin to a destination with a desired degree of information disclosure using the Physical Internet;
determining a first carrier for a first leg of the delivery based on the origin and an area coverage of the first carrier, wherein the first carrier is not provided destination information as dictated by the desired degree of information disclosure;
identifying a candidate list of other carriers for transporting the package along one or more subsequent legs based on the historical performances of each of the other carriers and the desired degree of information disclosure; and
determining a final carrier from the candidate list for a final leg of the delivery to which the destination information is disclosed.

2. The computer-implemented method of claim 1, wherein:
the request for delivery includes delivery directions relating to the destination; and
the delivery directions are disclosed to the final carrier and not to the first carrier.

3. The computer-implemented method of claim 2, wherein:
the package is shipped by at least the first carrier, a second carrier, and the final carrier; and
only the final carrier is informed of a location of the destination.

4. The computer-implemented method of claim 2, wherein the delivery directions include information on how to access the destination to deliver the package.

5. The computer-implemented method of claim 1, wherein identifying the candidate list includes referencing a deny list and a prioritized allow list of potential carriers.

6. The computer-implemented method of claim 1, wherein the final leg is a predetermined distance to the destination.

7. The computer-implemented method of claim 6, wherein a user that orders the package sets the predetermined distance.

8. The computer-implemented method of claim 1, further comprising verifying delivery of the package to the destination via a sensor.

9. A system comprising:
a processor; and
a memory in communication with the processor, the memory containing instructions that, when executed by the processor, cause the processor to:
receive a request for delivery of a package from an origin to a destination with a desired degree of information disclosure using the Physical Internet;
determine a first carrier for a first leg of the delivery based on the origin and an area coverage of the first carrier, wherein the first carrier is not provided destination information as dictated by the desired degree of information disclosure;
identify a candidate list of other carriers for transporting the package along one or more subsequent legs based on the historical performances of each of the other carriers and the desired degree of information disclosure; and
determine a final carrier from the candidate list for a final leg of the delivery to which the destination information is disclosed.

10. The system of claim 9, wherein:
the request for delivery includes delivery directions relating to the destination; and
the delivery directions are disclosed to the final carrier and not to the first carrier.

11. The system of claim 10, wherein:
the package is shipped by at least the first carrier, a second carrier, and the final carrier; and
only the final carrier is informed of a location of the destination.

12. The system of claim 10, wherein the delivery directions include information on how to access the destination to deliver the package.

13. The system of claim 9, wherein identifying the candidate list includes referencing a deny list and a prioritized allow list of potential carriers.

14. The system of claim 10, wherein the final leg is a predetermined distance to the destination.

15. The system of claim 14, wherein a user that orders the package sets the predetermined distance.

16. The system of claim 9, the memory containing additional instructions that, when executed by the processor, cause the processor to verify delivery of the package to the destination via a sensor.

17. A computer program product, the computer program product comprising a computer readable storage medium having program instructions embodied therewith, the program instructions executable by a computer to cause the computer to:
receive a request for delivery of a package from an origin to a destination with a desired degree of information disclosure using the Physical Internet;
determine a first carrier for a first leg of the delivery based on the origin and an area coverage of the first carrier, wherein the first carrier is not provided destination information as dictated by the desired degree of information disclosure;
identify a candidate list of other carriers for transporting the package along one or more subsequent legs based on the historical performances of each of the other carriers and the desired degree of information disclosure; and
determine a final carrier from the candidate list for a final leg of the delivery to which the destination information is disclosed.

18. The computer program product of claim 17, wherein:
the request for delivery includes delivery directions relating to the destination;
the delivery directions include information on how to access the destination to deliver the package;
the package is shipped by at least the first carrier, a second carrier, and the final carrier; and
only the final carrier is informed of a location of the destination and the delivery directions.

19. The computer program product of claim 17, wherein the final leg is a predetermined distance to the destination that is set by a user that orders the package.

20. The computer program product of claim 17, the computer readable storage medium containing additional program instructions that, when executed by the computer, cause the computer to verify delivery of the package to the destination via a sensor.
